(19) United States
(12) Patent Application Publication
(10) Pub. No.: US 2026/0292932 A1
(43) Pub. Date: Sep. 24, 2026

(54) DATA COMMUNICATIONS NETWORK UTILISING SATELLITE COMMUNICATIONS TO PROVIDE EMERGENCY ALERT WARNINGS

(71) Applicants: Mark Poidevin, Ellenbrook (AU); Matthew Poidevin, Wodonga (AU)

(72) Inventors: Mark Poidevin, Ellenbrook (AU); Matthew Poidevin, Wodonga (AU)

(21) Appl. No.: 19/469,885

(22) PCT Filed: Apr. 2, 2024
(86) PCT No.: PCT/AU2024/050309

§ 371 Date: Sep. 26, 2025

(30) Foreign Application Priority Data
Apr. 3, 2023 (AU) 2023900953

(51) Int. Cl. H04W 76/50; G08B 27/00; H04B 17/27; H04B 17/318; H04B 17/391

(52) U.S. Cl. CPC H04W 76/50; G08B 27/008; H04B 17/27; H04B 17/328; H04B 17/3913

(57) ABSTRACT

The present invention relates to a data communications network and a method for operating same utilizing satellite communications for providing emergency alert warnings. In particular, user locations are monitored according to the location of user devices and based on GPS location data transmitted by the user device. Satellite signal strength is monitored according to all available satellite signals in operable receiving range of the user device, and a satellite with the strongest signal or determined to be most likely to successfully transfer alert communications is automatically selected. Information is subsequently received regarding emergency or alert conditions, and alert warnings are issued to all user devices in the relevant geographical regions. Based upon receiving an alert warning, each user device in the relevant geographical region integrates with one or more input/output devices to communicate an emergency or alert condition audibly and/or visually.

### FIELD OF THE INVENTION

The present invention relates to a data communications network and a method of operating same utilizing satellite communications for providing emergency alert warnings.

### BACKGROUND OF THE INVENTION

There are different types of events that an individual may encounter in their lives which, if not avoided, are likely to result in adverse consequences for the individual. It is for this reason that humans have established systems and infrastructure to monitor factors that are likely to give rise to (or confirm the occurrence of) disruptive or dangerous events. Monitoring is conducted to enable individuals likely to be negatively impacted by such events to be notified in advance, preferably with sufficient time to enable the individual to take steps to avoid the event, or if that's not possible, to at least take action to minimize any adverse consequences or threat arising from the event.

In one example, the event may be an environmental emergency such as a flood, earthquake, or wildfire. Any individuals who are not adequately notified regarding the occurrence of such emergencies in their geographical location may react too late, and the likelihood of experiencing a negative consequence such as injury, death, property damage, etc, increases significantly. If an individual is appropriately warned, steps such as vacating a particular geographical location to avoid the event, or seeking protection within the geographical location, may be effected in a timely manner.

In another example, the event may be a road closure. If an individual is not warned of such an occurrence in advance of travelling towards the road closure, the individual may fail to reach their travel destination within an intended or preferred timeframe. There are various examples of other events that individuals are likely to prefer to avoid given the opportunity (ie. if notified in advance), including but not limited to floods, earthquakes, strong winds, storm conditions, vehicle accidents, road blockages, speed detection cameras, chemical spills, power outages, etc.

The above problems tend to be exacerbated in regional locations where cell (mobile) phone signal reception is often not available or unreliable, making it difficult or impossible for notifiers of such emergency events or conditions to communicate with such individuals for the purpose of providing advance warning. There have been several cases of reported incidents in which rural property owners have perished during bushfires since they were not contactable using cell phone communications (call, text message, etc) and therefore unaware regarding the imminent threat posed by the bushfire to their lives and property.

Accordingly, there is a need to provide individuals, particularly those who reside in regional locations, with an improved ability to receive, in a timely manner, emergency or alert warnings irrespective of whether cell phone signal reception is available.

Another problem arises when an emergency or alert warning is received by a data communications device (eg. cell phone, tablet, etc) of an individual in a regional location, but the individual fails to operate their device for a period of time (eg. while driving or working on their property) and hence fails to notice the emergency or alert warning. Accordingly, there is also a need for a solution capable of notifying individuals regarding the receipt of an emergency or alert warning on their devices irrespective of whether an individual is holding and/or operating their device.

The present invention seeks to mitigate the problems discussed herein, or at least seeks to provide an alternative solution to the problems associated with existing computing systems and methods for providing emergency or alert warnings initialising a data communications network.

The reference to any prior art in this specification is not, and should not be taken as, an acknowledgement or any suggestion, that the prior art forms part of the common general knowledge.

### SUMMARY OF THE INVENTION

In one aspect, the present invention provides a data communications network including connected data communications devices and a method of operating same to provide emergency alert warnings to users, the method including, monitoring user locations according to the location of user devices operable to receive satellite signals and transmit GPS location data, wherein monitoring the location of each user device is based upon the GPS location data transmitted by the user device, monitoring satellite signal strength according to all available satellite signals in operable receiving range of the user device according to the location of the user device, and automatically selecting a satellite with the strongest signal or a satellite determined to be most likely to successfully transfer alert communications, receiving information regarding emergency or alert conditions in respect of one or more geographical locations, issuing, utilizing the selected satellite, alert warnings to user devices in geographical regions for which an emergency or alert condition is applicable according to the received information regarding emergency or alert conditions, and based upon receiving the alert warning, integrating, by each user device in the geographical region for which the emergency or alert condition is applicable, with one or more input/output devices associated with the user that are in operable communication with the user device according to near field communications, such that any emergency or alert condition is communicated to each user audibly and/or visually using the one or more input/output devices.

In an embodiment, the user devices operable to receive satellite signals include one or more of, devices installed in vehicles, smartphone devices, computer tablets, or unmanned aerial vehicles.

In an embodiment, computer instruction code is operable on each user device to integrate the device with available input/output devices through the use of nearfield technology (eg. Bluetooth and/or short range wired connections). Examples of input/output devices include one or more of, wireless speakers, headphones, radio, or televisions.

In an embodiment, monitoring the geographical location of user devices according to the GPS location data transmitted by the devices is achieved using one or more of, a cell phone network, or one or more of the available satellites.

In an embodiment, a last recorded location of each user device is used when GPS location data transmitted by the user device is no longer received such that monitoring satellite signal strength, determining whether the user device is in the geographical region for which the emergency or alert condition is applicable, and issuing alert warnings to the user device, are in accordance with the last recorded location of the user device.

In an embodiment, the user device whose GPS location data is no longer received is continually monitored such that if the device location becomes available at a subsequent time, the location that is used for monitoring satellite signal strength, determining whether the user device is in the geographical region for which the emergency or alert condition is applicable, and issuing alert warnings to the user device, is updated according to the last recorded location of the user device.

In an embodiment, the emergency or alert conditions include one or more of vehicle accidents, emergency vehicle locations and/or routes of passage, road closures, flood affected roads and/or other blockages (eg tree obstruction), red light cameras and speed cameras, chemical spills, missing persons, natural disasters, criminal activity (eg. active shooters, robberies or bomb threats), power outages, wildfire, avalanche, earthquake, strong winds, typhoons, or tsunamis.

In an embodiment, the method further includes, implementing, using one or more artificial intelligence techniques, real time predictive analytic algorithms to predict a likely path of travel of individual users, and pre-emptively issue alert warnings to user devices whose users are predicted to travel a path toward a geographic location to which the alert warning applies.

In an embodiment, issuing alert warnings to user devices includes providing the user with information pertaining to the emergency and/or alert condition.

In an embodiment, the information pertaining to the emergency or alert condition includes one or more of, a type of the emergency or alert condition, a severity of the emergency or alert condition, evacuation instructions, safety recommendations, or a travel path to follow to avoid or exit the geographical location to which the emergency or alert condition applies.

In an embodiment, the method further includes, prompting a user to query the existence of a current emergency or alert condition applicable to a geographic location that is different to a current location of the user.

In an embodiment, the method further includes, based on receiving a query from the user, providing the user with information pertaining to any emergency or alert conditions applicable to the geographical location that is different to a current location of the user.

In an embodiment, the different geographic location is associated with a third party associated with the user including one or more of a family member, a friend, a colleague, or an associate, such that the user determines whether the other member is affected by a current emergency or alert condition.

In an embodiment, the method further includes, prompting a user to share a received alert warning with one or more third parties, wherein the sharing of a received alert warning is achieved using any available transmission method including one or more of, a cell phone network, a satellite network.

In an embodiment, each user device is configured to operate a software application that enables integration of the device with the one or more input/output devices associated with the user.

In an embodiment, each user device is configured to receive satellite signals, transmit GPS location data, and allow access to the software application including to integrate with the input/output devices, irrespective of there being an available cell phone network.

In an embodiment, the software application further provides a payment gateway to users that enables financial transactions to be initiated through each user's device including to enable the user to subscribe to use the software application or part functionality thereof.

According to another aspect, the present invention provides a computer-implemented method for providing emergency alert warnings to users, the method including, monitoring, by one or more processors, user locations according to the location of user devices operable to receive satellite signals and transmit GPS location data, wherein monitoring the location of each user device is based upon the GPS location data transmitted by the user device, monitoring, by one or more processors, satellite signal strength according to all available satellite signals in operable receiving range of the user device according to the location of the user device, and automatically selecting a satellite with the strongest signal or a satellite determined to be most likely to successfully transfer alert communications, receiving, by one or more processors, information regarding emergency or alert conditions in respect of one or more geographical locations, issuing, by one or more processors, utilizing the selected satellite, alert warnings to user devices in geographical regions for which an emergency or alert condition is applicable according to the received information regarding emergency or alert conditions, and based upon receiving the alert warning, integrating, by each user device in the geographical region for which the emergency or alert condition is applicable, with one or more input/output devices associated with the user that are in operable communication with the user device according to near field communications, such that any emergency or alert condition is communicated to each user audibly and/or visually using the one or more input/output devices.

According to a further aspect, the present invention provides a non-transitory computer-readable medium including computer instruction code that, when executed on a computer, causes one or more processors of the computer to perform the steps of, monitoring user locations according to the location of user devices operable to receive satellite signals and transmit GPS location data, wherein monitoring the location of each user device is based upon the GPS location data transmitted by the user device, monitoring satellite signal strength according to all available satellite signals in operable receiving range of the user device according to the location of the user device, and automatically selecting a satellite with the strongest signal or a satellite determined to be most likely to successfully transfer alert communications, receiving information regarding emergency or alert conditions in respect of one or more geographical locations, issuing, utilizing the selected satellite, alert warnings to user devices in geographical regions for which an emergency or alert condition is applicable according to the received information regarding emergency or alert conditions, and based upon receiving the alert warning, integrating, by each user device in the geographical region for which the emergency or alert condition is applicable, with one or more input/output devices associated with the user that are in operable communication with the user device according to near field communications, such that any emergency or alert condition is communicated to each user audibly and/or visually using the one or more input/output devices.

In yet another aspect, the present invention provides a user device operable to connect with and transceive data with a data communications network to receive emergency alert communications the user device: monitoring physical location of the device according to GPS location functionality of the device and transmitting current location data to the data communications network; monitoring satellite signal strength in respect of all available satellite signals in operable range of the user device, the user device automatically selecting the satellite with the strongest reception signal or a satellite determined to be the most likely from which the user device will receive emergency alert communications; receiving information regarding emergency alert communications in respect of one or more geographical locations relevant to the current location of the user device; integrating with one or more input/output devices in operable communication range of the user device such that any emergency alert communications are audibly and/or visually indicated by one or more input/output devices.

### BRIEF DESCRIPTION OF THE DRAWINGS

Embodiments of the invention will now be described in further detail with reference to the accompanying Figures which:

FIG. 1 provides an overview of a data communications network according to an embodiment of the present invention detailing, in particular, the interaction of various network components;

FIG. 2 illustrates an exemplary diagram associated with the server component within the network illustrated in FIG. 1;

FIG. 3 illustrates a diagram of a process that enables a user to utilise a data communications device to download and install a software application, and subsequently access, or register to use, the software application for interaction with the network illustrated in FIG. 1, including to register one or more input/output devices;

FIG. 4 illustrates a diagram associated with an example interface of the software application that provides users with the ability to search for emergency or alert conditions and information associated therewith, including contact details of relevant emergency authorities;

FIG. 5 illustrates a diagram associated with an example interface of the software application configured to receive alerts based on the user device being located in a geographical region for which an emergency or alert condition is applicable, and a further example interface that enables users to avoid or vacate the geographical region;

FIG. 6 illustrates a diagram associated with a further example interface of the software application for integrating with one or more input/output devices that are in operable communication with a device of the user according to near field communications such that any alert received by the user device is communicated audible or visually to the user using the input/output device; and

FIG. 7 illustrates a diagram of further example interfaces including a drone alert interface and an alert sharing interface.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. However it will be readily apparent that the current disclosure may be practiced without limitation to the specific details. In other instances, some features have not been described in detail to avoid obscuring the present disclosure.

The present invention, according to an embodiment, relates to a computer-implemented data communications network and method for providing an emergency alert warning in the form of an audible and/or visual notification (90) to users (30). The network and method provide a platform that hosts a computer-executable software application (40), wherein the application (40) is accessible by a plurality of such users (30). The platform enables data communication devices (50) associated with users (30) in geographical regions for which an emergency or alert condition (85) is applicable to receive alerts (80) using available satellite communications (65). Such alerts are subsequently communicated to each user (30) audibly and/or visually using one or more input/output devices (60) that are in operable communication with the user devices (50) according to Near Field Communications (NFC). Since the alerts (90) are sent to the user devices (50) using available satellite communications (65), the alerts (90) may be received and subsequently communicated to near field input/output devices (60) irrespective of the availability of cell phone communication means.

The platform is provided by a central server (20) which maintains one or more processors and/or databases for performing functions, including monitoring user locations (55) according to the location of the user devices (50). The user devices (50) are of the type that are operable to receive satellite signals and also transmit GPS location data. The server (20) is further configured to monitor satellite signal strength according to all available satellite signals (65) in operable receiving range of the user device (50) according to the location (55) of the user device (50), and automatically select the satellite (70) with the strongest signal, or a satellite that is likely to result in an alert reaching the user device (50) in the shortest amount of time.

Accordingly, as information is received regarding emergency or alert conditions (85) in respect of one or more geographical locations, the most appropriate satellite (70) (eg. with the strongest signal) is selected and utilised to issue alerts (80) to all user devices (50) in the one or more geographical regions for which the emergency or alert condition (85) is applicable. Based upon receiving the alert (80), each user device (50) integrates with one or more near field input/output devices (60) (e.g. wireless speakers, headphones, televisions, etc, of the user (30)) such that the emergency or alert condition (85) is automatically communicated to the user (30) audibly and/or visually via the one or more input/output devices (60).

The person skilled in the relevant field of technology will appreciate that the platform provides a solution to existing problems with ensuring that individuals are notified in advance regarding emergency events that are likely to be encountered, and providing sufficient information to enable the individual to take steps to avoid the event or take action necessary to minimize adverse consequences. In addition, by ensuring that not only the user's handheld smartphone device (for example) receives the alert (80), with at least one other device (the input/output devices (60)) providing an audible and/or visual representation of the emergency or alert condition (85)), individuals are more likely to recognize when such alerts have been issued.

In view of at least the above practical and useful results and the effects that arise from the described implementation of the present invention, the use and interaction between the user devices (50), input/output devices (60), satellite (70) and server (20) in respect of which the software application (40) is operated, represents a technical advance as compared with existing emergency or alert notification technologies currently available to individuals.

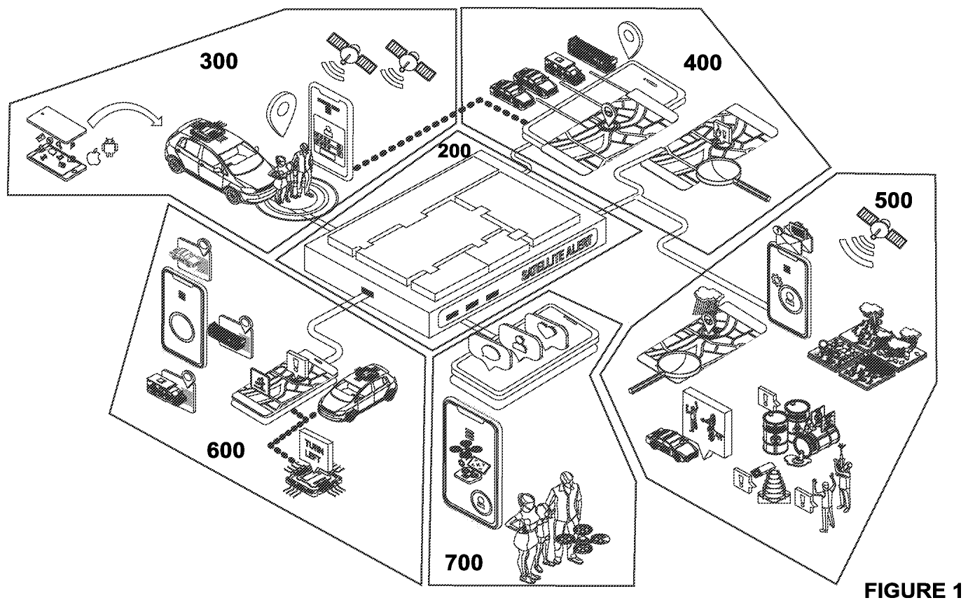

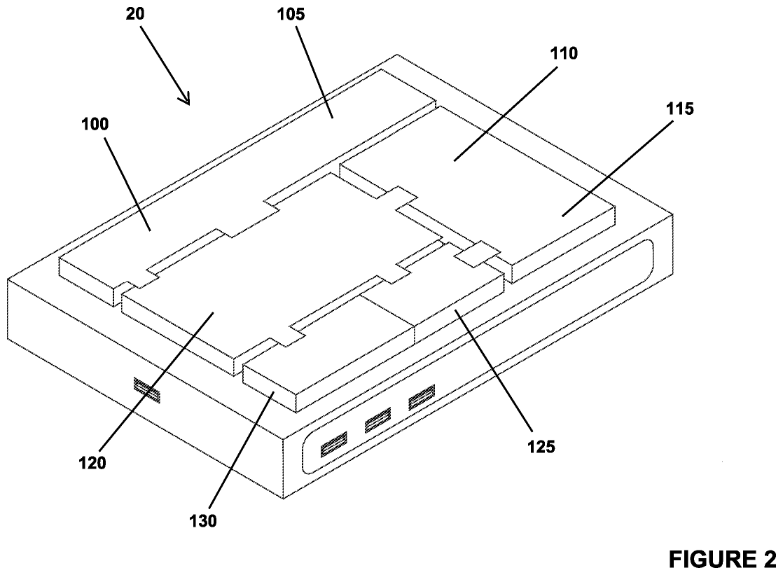

FIG. 1 is divided into Segments which are further expanded into subsequent FIGS. 2 to 7. In particular, Segment 200 of FIG. 1 shows the server component (20) with which a software application (40) operating on a data communication device (50) of a user (30) is configured to communicate. It will be apparent to the person skilled in the relevant field of technology that the software application (40) may be a mobile application or a web application and that, similarly, data communication device (50) utilised by the user (30) may be a portable device or fixed location computing device. Such devices (50) will, as a minimum, need to be capable of receiving satellite signals and transmitting GPS location data for reasons that will become apparent below.

Examples of portable devices include mobile (cell) phones and computer tablets, and examples of fixed location computing devices include workstations and personal computers. The server component (20) is additionally detailed in FIG. 2.

The skilled person will further appreciate that the steps described herein may be executed by the user devices (50), wherein such operations are facilitated via the software application (40) operating on each device (50). According to another implementation, the server (20) may be programmed to provide all, or most, of the processing functions described herein, where they cannot be provided locally on the user devices (50), or where it may be commercially or technically impractical to implement such arrangements.

Of course, particularly when there is a lack of cell phone reception, some operations will not be able to be undertaken by server (20) and those operations will only be capable of being implemented using the device (50) held by the user (30), including for example to integrate with input/output devices (60) according to near field communications, and to communicate with available satellites (65) for the purpose of receiving alerts (80). Whilst there are some steps which can only be performed by the user devices (50) and/or the input/output devices (60), as described above, other steps may be performed using hardware that is located externally of such devices such as the remote central server (20) for example (ie. in a distributed architecture).

Segment 300 of FIG. 1 shows how the server (20) may be configured for communication with the user devices (50) (when appropriate network communications exist and are reliable) and also communication with available satellites (65).

When a user (30) first registers to use the software application (40), they may do so using their device (50) at a time when their device (50) is connected to an appropriate network that enables the download and installation of such applications. In this regard, the server (20) may receive data from the devices (50) for the purpose of creating a user profile, e.g. based upon the entry of details of the user (30). Segment 300 of FIG. 1 shows a user (in the embodiment shown a family) at a particular location (55) downloading and installing the application (40) onto their device (50) and subsequently accessing the application (40) to establish an account and profile.

It will be appreciated that the software application (40) once downloaded and installed onto a user device (50) may function irrespective of the device (50) being connected to a cell or similar network since in some situations, such network connectivity may not exist or may not be reliable. Accordingly, the device (50) needs to be configured such that it has the ability to receive satellite signals and transmit GPS location data, and allows software application (40) to be operated by users (30), irrespective of there being an available cell phone network.

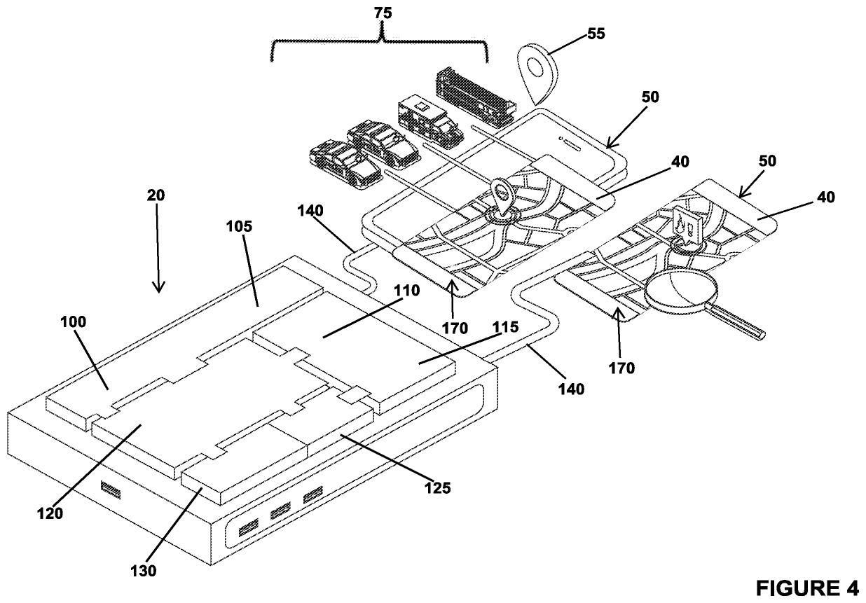

Emergency and alert condition information may be retrieved by the server (20) from one or more external databases associated with relevant authorities such as police, ambulance, bureau of meteorology, etc. The software application (40) may be configured to automatically synchronise with disaster and emergency data stored externally. Such information may also include data that has been retrieved based on notifications provided to or transmitted from emergency vehicles (75). Segment 400 of FIG. 1 shows a search facility interface (170) that enables users (30) to search for information pertaining to active emergency and alert conditions, as further detailed in FIG. 4.

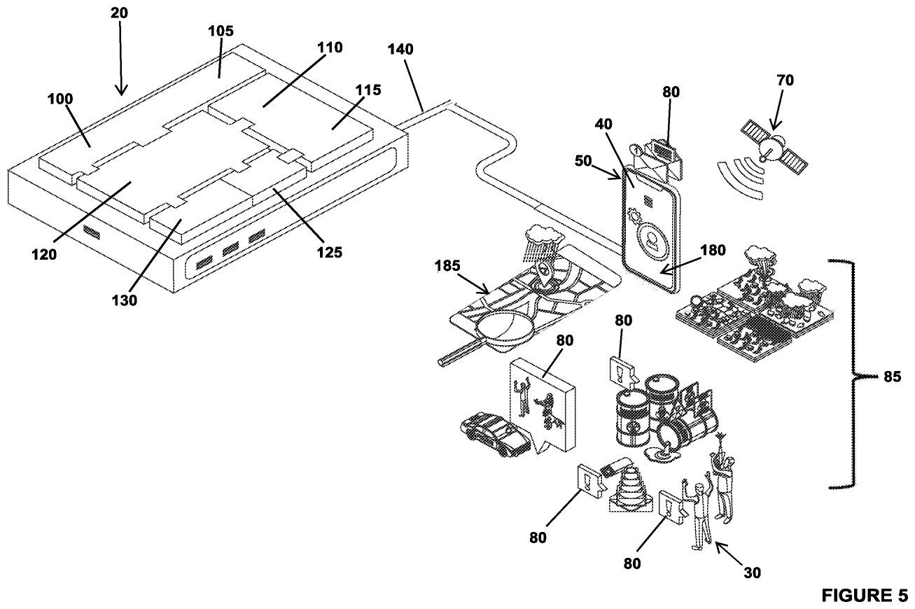

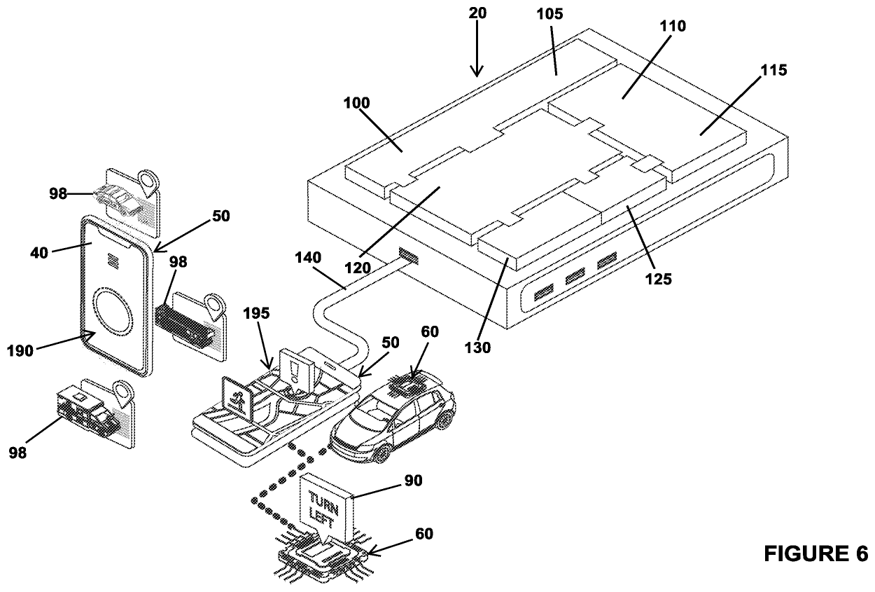

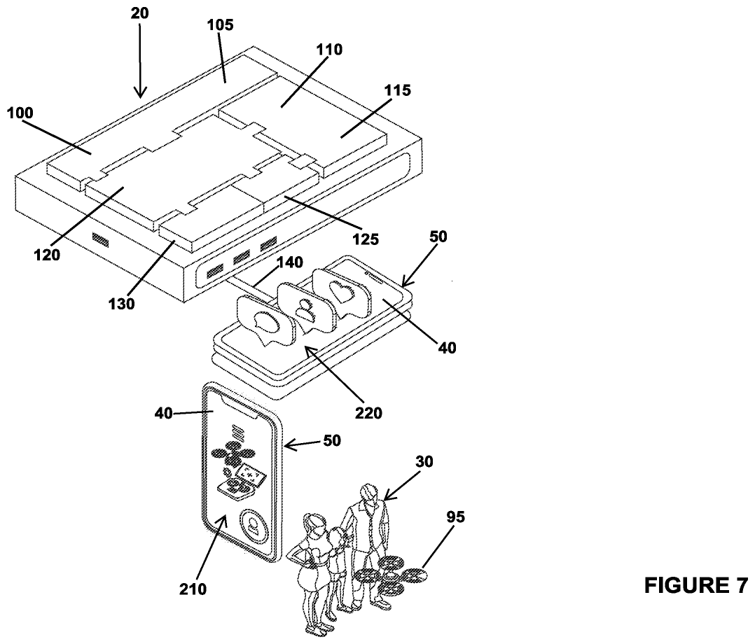

Segment 500 of FIG. 1 shows an interface (180) for receiving alerts (80) based on detected emergency or alert conditions (85) and a further interface (185) that may be utilized by users to navigate away from such events, as further detailed in FIG. 5. Segment 600 of FIG. 1 shows interface (190) that enables integration and communication with input/output devices (60) that are associated with the user (30) and are in operable (near field) communication range with the user device (50). Such devices (60) ultimately provide the audible and/or visual notification (90) to users (30), as further detailed in FIG. 6. Finally, Segment 700 of FIG. 1 shows additional example interfaces (210) and (220) including a drone alert interface (210) which may be used when drones (95) are utilised to receive alerts (80), and a sharing interface (220), as further detailed in FIG. 7.

As mentioned above, FIG. 2 shows in greater detail Segment 200 of FIG. 1 and, in particular, FIG. 2 shows the server component (20) which includes infrastructure upon which the platform of the present invention operates. The infrastructure may be local or cloud-based.

The central server (20) may operate one or more computer processors and/or maintain one or more databases to enable the following functionality and/or storage:
User account register (100) storing details relating to all registered users (30). For examples, such details may include, but are not limited to, name, age, address, contact details, family member details, staff details, details relating to a property associated with the user (30) including equipment, installations and other infrastructure that may assist the user (30) when confronted with a particular emergency situation, details relating to communication means available on the user's property, additional details relating to the property including a number of animals, etc, and any additional details which may be relevant for the purpose of identifying each user;
Emergency authority/personnel register (105) storing details relating to all registered emergency authorities including the name, location and category associated therewith. Register (105) may integrate with external systems and databases to retrieve the most up to date information regarding emergency or alert conditions (85) in respect of one or more geographic locations, including the current location of mobile units associated with such authorities (e.g. police cars, ambulances, etc);
Satellite information register (110) storing details relating to known available satellites (65) which are capable of receiving communications from the server (20) (in the form of alerts (80)) and transmitting same to all user devices (50) in geographical regions for which the particular emergency or alert condition (85) is applicable (ie. according to the information received from emergency personnel/services). The satellite information register may also include historical information relating to the satellites that were previously utilised for such purposes, which satellites had the strongest signal and when, which satellites performed better than others in relation to receiving and forwarding alerts (80), etc. Such information may be utilised to train a machine learning model in order to facilitate future satellite selection, i.e. when new alerts (80) are required to be transmitted to user devices (50);
Devices register (115) storing details relating not only to user devices (50) registered by users (30) but also their associated input/output devices (60) which are configured to integrate with user devices (50) and provide audible and/or visual alerts (90) to users (30) according to Near Field Communications (NFC). The storage of such information may prove useful when seeking to determine the types of devices that are being carried by or are within the vicinity of a user (30) on their property, vehicles, etc, and hence the likelihood of alerts reaching the user (30);
Data processing functionality (120) for processing user input commands and additional received data, and generating outputs for display in software application (40). For example, functionality (120) may be responsible for monitoring user locations (55) as well as satellite signal strength associated with all available satellites (65) in operable receiving range of the user devices (50), and may utilise a trained machine learning model to select a satellite with the strongest signal (or the strongest potential to cause an alert (80) to reach a user (30) in the shortest amount of time). Further, the functionality (120) will cause alerts (80) to be transmitted to user devices (50) via the selected satellite (70). The functionality (120) may also be responsible for monitoring the presence of additional communication means such as cell network communications and cause communications to be made via such networks when available, rather than relying solely upon a satellite communication link;
Sharing functionality (125) that enables integration with various other software applications or platforms including social media platforms (eg. using an application programming interface (API)) in order to enable alerts (90) to be shared with select contacts of the user (30) (e.g. social media connections), with relevant emergency authorities, etc. This may be particularly useful in situations where the user (30) is only able to receive information via satellite and hence has no means by which to share the emergency information with friends, family, etc; and
Payment gateway (130) that enables any financial transactions required to be made using the software application (40) to be managed, including payments made by registered users (30) to a platform administrator (e.g. payment of subscription fees).

FIG. 2 also depicts that server (20) is configured to enable communication with the devices (50) via cell network connection when available, or via available satellites (65). Such communications will be received and processed using the software application (40) operating on each user device (50). In other words, when a data communications network such as the cell network or similar is available, the server (20) may communicate directly with the devices via the available network. However, in instances where such communication means are not available, then the server (20) may automatically revert to communications via satellite (70).

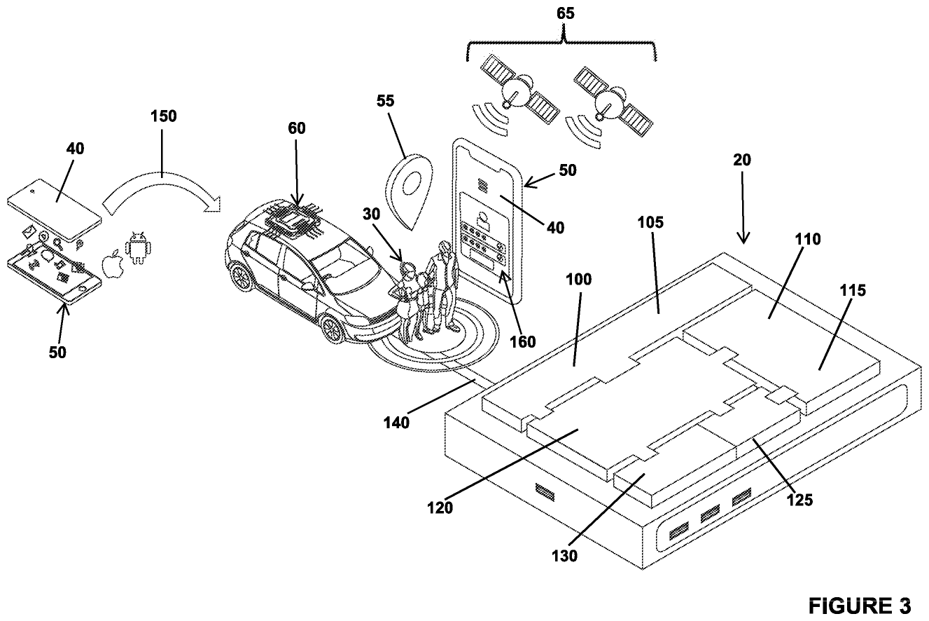

FIG. 3 shows in greater detail the various components depicted in Segment 300 of FIG. 1 and, in particular, the steps associated with a user (30) installing (150) the software application (40) on the software devices (50) and subsequently accessing a user login and registration interface (160) associated with the application (40). Such access may be granted after the user (30) has installed the application (40) which may be achieved by downloading the application from an application store. Each user (30) may create an account (which may include a user profile) using the application (40) and the account/profile information may be stored in the user account database (100).

As previously descried, the user devices (50) operable to receive satellite signals need not necessarily be restricted to mobile phone devices, but may further include devices installed in vehicles, computer tablets, drones (95) and any other communication devices capable of receiving satellite signals.

In addition to being capable of receiving satellite signals, such devices (50) will also be capable of transmitting GPS location data in order to enable monitoring of the location of each user device (50) according to GPS location data transmitted by devices (50). Such information may be stored in the user account register (100). By monitoring the location of devices (50), the system can ascertain which user devices (50) are in geographical regions in which an emergency or alert condition (85) has been detected, and hence target those particular devices (50) during the issuance of alerts (80).

In the event that the monitoring of GPS location data of a user device (50) is not possible or there is a recorded failure to receive updated geographical locations from a user device (50), then a known last location may be recorded and utilised for the purpose of determining whether the device (50) is in a compromised location. In this regard, each user device (50) may be continually monitored such that if the device location does become available at a subsequent point in time, the recorded GPS location of the user device (50) may be updated accordingly.

FIG. 4 shows in greater detail the various components depicted in Segment 400 of FIG. 1 and, in particular, an interface (170) that enables users (30) to utilise the software application (40) to view and/or query any current emergency or alert conditions (85) applicable to a geographic location that is the same or different to the current location (55) of the user (30) (eg. geolocation of a family member or associate). In the latter scenario, the user (30) may use the interface (170) to determine whether a family member or associate is affected by a current emergency or alert condition (85). As mentioned previously, such information may be retrieved by the server (20) from emergency authorities including notifications sent to or transmitted by emergency vehicles (75). There may also be circumstances where emergency authorities utilise the software application (40) themselves in order to enable their personnel, including those travelling in emergency vehicles (75), to utilise the application functionality to determine the location and nature of emergency or alert conditions (85).

FIG. 5 shows in greater detail the various components depicted in Segment 500 of FIG. 1 and, in particular, examples of various different emergency or alert conditions (85), as well as alerts (80) that are generated in respect thereof. FIG. 5 also illustrates the utilization of an alert receipt interface (180) associated with the user device (50) for receiving alerts (80) via a satellite (70) that has been selected based upon, for example, the strongest signal strength.

Examples of emergency or alert conditions (85) may include, but are not limited to, vehicle accidents, emergency vehicle locations, and/or routes of passage, road closures, flood affected roads and/or other blockages e.g. tree obstruction, red light cameras and speed cameras, chemical spills, missing persons, natural disasters, criminal activity (eg. active shooters, robberies or bomb threats), power outages, wild fire, avalanche, earth quake, strong winds, typhoons and/or tsunamis.

The alerts (80) may include a range of information pertaining to the emergency or alert condition (85) such as location data, information pertaining to the type and severity of the emergency or alert condition (85), recommendations which may include evacuation instructions, emergency contacts, etc.

It will be appreciated that the platform is not only useful for users (30) who find themselves in situations involving an emergency or alert condition (85), but also users (30) who may be unwittingly travelling towards a location in which an emergency or alert condition (85) is applicable. In this regard, a further interface (185) is shown in FIG. 5 in which the user (30) is provided with a visual and/or audible indication of the most appropriate travel path to follow to avoid a geographical location in which an emergency or alert condition (85) has been recorded. Indeed, interface (185) may also be useful for users who are present at the relevant geographical location, since the interface (185) may also provide instructions regarding the most effective and safest way to vacate the particular geographical location.

Users (30) may also be automatically notified that they are or may be travelling towards a particular geographical location to which the emergency or alert condition (85) applies. For example, real time predictive analytic algorithms may be applied to predict the likely path of travel of users (30) in order to pre-emptively issue emergency and alert warnings in accordance with a prediction that a user (30) is travelling a path towards the relevant geographic location.

FIG. 6 shows in greater detail Segment 600 of FIG. 1 and, in particular, a further exemplary interface (190) of the software application (40) that enables users (30) to integrate their software application (40) with the one or more input/output devices (60). The input/output devices (60) are, in the example shown, mounted to various vehicles (98) owned and operated by the user (30) such that in the event that an alert (80) is received, the user (30) should receive the relevant signal (90) irrespective of which vehicle the user is driving and irrespective of whether the user is carrying their device (50). For example, there may be instances where the user (50) has their device stored in their home and is using an agricultural vehicle which has an input/output device (60) mounted. Provided the input/output device (60) is within near field vicinity to receive a signal from the device (50), then the user (30) can be appropriately notified.

It will be appreciated that there will be multiple input/output devices (60) for alerting the user (30) regarding the receipt of alerts (80), and these will not be limited to vehicle-mounted devices.

The input/output device (60) may not only provide details of the alert (80), but may also provide audible and/or visual instructions to the user (30), as shown in interface (195) of FIG. 6. Such instructions may provide the user (30) with the most appropriate travel path to follow to avoid or exit the geographical location in which the emergency or alert condition is occurring (eg. providing directions to the user such as ‘take the first exist”, “take the second exit”, etc, when the user is confronted with a traffic light or similar juncture where there are multiple paths available for selection).

FIG. 7 shows in greater detail Segment 700 of FIG. 1 and, in particular, the use of an unmanned aerial vehicle (UAV) in the form of a drone (95) which is utilised for receiving alerts (80) from the server (20) via satellite (70). In this regard, the drone (95) may forward alerts (80) to the user devices (50), or alternatively, the drone (95) may be configured to transmit a signal to nearby input/output devices (60) directly by near field communications, similar to the way in which the user device (50) was previously described as causing near field input/output devices (60) to provider audible and/or visual alerts to users (30).

The use of drones (95) and similar flying vehicles may represent a preferred means of receiving satellite signals in view of their ability to more successfully capture such signals (80) due to their ability to fly high in the sky (as compared with the use of ground-based devices). Such drones (95) may also be useful in circumstances where a user (30) may be experiencing difficulty capturing satellite signals using their handheld device (50). In such an emergency situation, the user (30) may deploy the drone (95) to effectively act as an alert receiving device which may then forward such alerts to the user device (50) and/or the input/output devices (60). In this regard, a user (30) may witness an emergency or alert condition (85) unfolding before them, but they may still prefer to connect to an available satellite for the purpose of receive alerts (80) since, as described earlier, the alert (80) will include additional information and recommendations that would otherwise not be available to the user (30).

FIG. 7 also shows a sharing interface (220) which may be configured to prompt users to share received alerts (80) with one or more contacts of the user (30) (eg. friends, family, employees, members and associates), wherein the sharing of a received alert (80) is achieved using any transmission network available to the user including a cell phone network if available, or using available satellite network communications as previously described.

The platform may also utilize artificial intelligence techniques in order to improve the information displayed to users (30), the speed at which such information reaches the user (30). Some examples of available artificial intelligence techniques have already been described above. It will be understood that artificial intelligence techniques can significantly improve the platform's ability to process large volumes of data in substantially real-time, thereby enhancing the accuracy and timeliness of emergency alerts (80).

In a further example, machine learning models can analyze patterns in satellite data to predict emergencies before they occur, providing users with more actionable alerts (80). Deep learning algorithms may be used to analyze environmental data to predict natural disasters with greater accuracy, while natural language processing (NLP) may be used to access and filter social media and news sources for real-time indicators of emerging threats. Artificial intelligence techniques may also be used to refine the selection process for the most reliable satellite communication channels, using predictive models to anticipate signal availability and strength. This will ensure the most efficient path for emergency alerts, even in challenging conditions.

Regarding satellite selection, the use of artificial intelligence techniques may also automate and optimize the monitoring of user locations and satellite signal strengths using algorithms that adapt to users' movement patterns and satellite dynamics. This may assist in dynamically selecting the best satellite for communication, ensuring robust connectivity for delivering alerts.

One or more artificial intelligence techniques may also be used to monitor the last known location of a user, employing predictive analytics to forecast the user's potential movements, thereby enhancing the accuracy of delivering emergency alerts (80) to those who might have moved from their previously recorded location. Utilizing artificial intelligence techniques for real-time predictive analytics may improve how the network anticipates user paths and potential emergencies. For example, by integrating historical data, current conditions, and predictive models, the system may pre-emptively warn users (30) about potential dangers ahead of their path. In this regard, users (30) may also be guided away from danger zones and provided with optimized evacuation routes and real-time updates as situations evolve. The use of such techniques may also personalise the emergency alert experience by learning user preferences over time and tailoring alert delivery methods (audio, visual, etc) to ensure the most effective communication.

It will be appreciated that the incorporation of artificial intelligence techniques, and particularly deep learning, satellite selection and alert dissemination processes may optimize and enhance the data communications network's responsiveness and reliability. For example, alert protocols may be automatically adjusted according to factors such as the severity of an emergency or alert condition (80), the number of people affected, and the geographical area affected.

According to one example, such a platform could be utilized to predict the path of a wildfire and pre-emptively transmit alerts (80) to users (30) in the projected path, advising users regarding safe evacuation routes before the situation becomes critical. In another example, such a platform could be used to analyze, using one or more machine learning models, user interaction with past alerts (80) to customize future alert deliveries, including but not limited to recognizing that a visual alert may be more suitable than an audio alert since during a previous emergency or alert condition the user (30) missed an audio alert due to working in a noisy environment or lack of hearing ability.

A person skilled in the relevant field of technology will appreciate that the integration of artificial intelligence techniques as described above improves the platform, from monitoring and selecting communication channels to issuing and personalizing alerts (80). The techniques described will increase efficiencies and effectiveness in each process, ensuring that the platform not only meets its intended purpose but also continuously improves through learning and adaptation. Examples of artificial intelligence platforms that may be suitable for performing the artificial intelligence techniques described herein include, but are not limited to, ChatGPT and Google DeepMind.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1-21. (canceled)

22. A data communications network and a method of operating same for providing emergency alert warnings to users, the method operated within the data communications network comprising:
monitoring, by a server of the data communications network, user locations according to the location of user devices configured to operate a software application that enables the devices to receive satellite signals and transmit GPS location data, wherein monitoring the location of each user device is based upon the GPS location data transmitted by the user device;
monitoring, by the server, satellite signal strength according to all available satellite signals in operable receiving range of the user device according to the location of the user device, and automatically selecting a satellite with the strongest signal or a satellite determined to be most likely to successfully transfer alert communications;
receiving, by the server, information regarding emergency or alert conditions in respect of one or more geographical locations;
issuing, by the server utilizing the selected satellite, alert warnings to selected user devices located in geographical regions for which an emergency or alert condition is applicable according to the received information regarding emergency or alert conditions; and
based upon the server receiving the alert warning, causing, by the server, via the software application each selected user device in the geographical region for which the emergency or alert condition is applicable, to integrate with one or more input/output devices associated with the user that are in operable communication with the user device according to near field communications, such that any emergency or alert condition is automatically communicated to each user audibly and/or visually using the one or more input/output devices.

23. The data communications network of claim 22, wherein the user devices operable to receive satellite signals comprise one or more of:
devices installed in vehicles,
smartphone devices,
computer tablets, or
unmanned aerial vehicles.

24. The data communications network of claim 22, wherein the input/output devices comprise one or more of:
wireless speakers,
headphones,
radio, or
televisions.

25. The data communications network of claim 22, wherein said near field communications comprise one or more of:
Bluetooth, or
short range wired connections.

26. The data communications network of claim 22, wherein monitoring the geographical location of user devices according to the GPS location data transmitted by the devices is achieved using one or more of:
a cell phone network, or
one or more available satellites.

27. The data communications network of claim 26, wherein a last recorded location of each user device is used when GPS location data transmitted by the user device is no longer received such that monitoring satellite signal strength, determining whether the user device is located in the geographical region for which the emergency or alert condition is applicable, and issuing alert warnings to the user device, are in accordance with the last recorded location of the user device.

28. The data communications network of claim 27, wherein the user device whose GPS location data is no longer received is continually monitored such that if the device location becomes available at a subsequent time, the location that is used for monitoring satellite signal strength, determining whether the user device is in the geographical region for which the emergency or alert condition is applicable, and issuing alert warnings to the user device, is updated according to the last recorded location of the user device.

29. The data communications network of claim 22, wherein the emergency or alert conditions comprise one or more of:
vehicle accidents,
emergency vehicle locations and/or routes of passage,
road closures,
flood affected roads and/or other blockages,
red light cameras and speed cameras,
chemical spills,
missing persons,
natural disasters,
criminal activity,
power outages,
wildfire,
avalanche,
earthquake,
strong winds,
typhoons, or
tsunamis.

30. The data communications network of claim 22, wherein the method further comprises:
implementing, by the server using one or more artificial intelligence techniques, real time predictive analytic algorithms to predict a likely path of travel of individual users, and
pre-emptively issue, by the server, alert warnings to user devices whose users are predicted to travel a path toward a geographic location to which the alert warning applies.

31. The data communications network of claim 22, wherein issuing alert warnings to user devices comprises providing the user with information pertaining to the emergency and/or alert condition.

32. The data communications network of claim 31, wherein the information pertaining to the emergency or alert condition comprises one or more of:
a type of the emergency or alert condition,
a severity of the emergency or alert condition,
evacuation instructions,
safety recommendations, or
a travel path to follow to avoid or exit the geographical location to which the emergency or alert condition applies.

33. The data communications network of claim 22, wherein the method further comprises:
prompting, by the server, a user to query the existence of a current emergency or alert condition applicable to a geographic location that is different to a current location of the user.

34. The data communications network of claim 33, wherein the method further comprises:
based on receiving a query from the user, providing the user with information pertaining to any emergency or alert conditions applicable to the geographical location that is different to a current location of the user.

35. The data communications network of claim 33, wherein the different geographic location is associated with a third party associated with the user comprising one or more of a family member, a friend, a colleague, or an associate, such that the user determines whether the other member is affected by a current emergency or alert condition.

36. The data communications network of claim 22, wherein the method further comprises:
prompting, by the server, a user to share a received alert warning with one or more third parties, wherein the sharing of a received alert warning is achieved using any available transmission method comprising one or more of:
a cell phone network,
a satellite network.

37. The data communications network of claim 22, wherein each user device is configured to receive satellite signals, transmit GPS location data, and allow access to the software executing within the user device to integrate the input/output devices, irrespective of an available cell phone network.

38. The data communications network of claim 22, wherein the software application further provides a payment gateway to users that enables financial transactions to be initiated through each user's device comprising an ability for the user to subscribe to use the software application or part functionality thereof.

39. A computer-implemented method for providing emergency alert warnings to users, the method comprising:
monitoring, by a server of a data communications network, user locations according to the location of user devices configured to operate a software application that enables the devices to receive satellite signals and transmit GPS location data, wherein monitoring the location of each user device is based upon the GPS location data transmitted by the user device;
monitoring, by the server, satellite signal strength according to all available satellite signals in operable receiving range of the user device according to the location of the user device, and automatically selecting a satellite with the strongest signal or a satellite determined to be most likely to successfully transfer alert communications;
receiving, by the server, information regarding emergency or alert conditions in respect of one or more geographical locations;
issuing, by the server, utilizing the selected satellite, alert warnings to selected user devices located in geographical regions for which an emergency or alert condition is applicable according to the received information regarding emergency or alert conditions; and
based upon the server receiving the alert warning, causing, by the server via the software application, each selected user device in the geographical region for which the emergency or alert condition is applicable, to integrate with one or more input/output devices associated with the user that are in operable communication with the user device according to near field communications, such that any emergency or alert condition is automatically communicated to each user audibly and/or visually using the one or more input/output devices.

40. A user device operable to connect with, and transceive, data with a data communications network comprising to receive emergency alert communications, wherein the user device:
operates a software application that enables the device to receive satellite signals and transmit GPS location data, and to monitor the physical location of the device according to GPS location functionality of the device and transmit current location data to a server of the data communications network;
monitors satellite signal strength in respect of all available satellite signals in operable range of the user device, the user device automatically selecting the satellite with the strongest reception signal or a satellite determined to be the most likely satellite from which the user device will receive emergency alert communications;
receive, via the selected satellite an alert warnings based on the device located in a geographical region for which an emergency or alert condition is applicable according to information received by the server regarding emergency alert communications in respect of one or more geographical locations;
integrates with one or more input/output devices in operable communication range of the user device such that any emergency alert communications are automatically communicated to the user audibly and/or visually using the one or more input/output devices.
